(19) United States
(12) Patent Application Publication
(10) Pub. No.: US 2015/0378178 A1
(43) Pub. Date: Dec. 31, 2015

(54) APPARATUS FOR ENHANCING DISPLAY READABILITY IN AN ENVIRONMENT WITH STRONG AMBIENT LIGHT

(71) Applicant: Google Technology Holdings LLC, Mountain view, CA (US)

(72) Inventors: Sen Yang, Palatine, IL (US); Roger W. Ady, Chicago, IL (US); John W. Kaehler, Mundelein, IL (US); Jiri Slaby, Buffalo Grove, IL (US); Zhiming Zhuang, Palatine, IL (US)

(21) Appl. No.: 14/332,414

(22) Filed: Jul. 16, 2014

Related U.S. Application Data
(60) Provisional application No. 62/018,856, filed on Jun. 30, 2014.

(51) Int. Cl. G02C 7/10; G02C 7/12

(52) U.S. Cl. CPC G02C 7/104; G02C 7/12; G02C 7/107; G02C 2202/16

(57) ABSTRACT

An apparatus for enhancing display readability in an environment with strong ambient light can include an eyewear frame configured to be worn by a user, the eyewear frame including a lens holding portion. The apparatus can include at least one lens connected to the lens holding portion of the eyewear frame. The apparatus can include a multi-band pass filter coupled to the at least one lens, the multi-band pass filter can be configured to pass visible red, visible green, visible blue, and visible yellow light emitted through the lens from the display and configured to attenuate other visible and non-visible wavelengths of light through the lens.

### BACKGROUND

1. Field

The present disclosure is directed to an apparatus for enhancing display readability in an environment with strong ambient light.

2. Introduction

Presently, devices with displays are used in a variety of lighting conditions. Such devices include smartphones, tablet computers, smart watches, laptops, televisions, monitors, and other devices that have a display. For example, a portable electronic device is used in both indoor and outdoor environments during the day and at night. The display of the portable electronic device is easy to view in low and moderate ambient light. For example, in the dark, a typical display has high contrast, good color, and good brightness. However, the display becomes more difficult to view when there is bright ambient light, such as in the sunlight outdoors, near windows indoors, near bright indoor lights, and in other bright ambient light conditions. In bright ambient light conditions, the display has lower contrast due to noise, such as unwanted reflection, and due to lower color purity. Additionally, in bright ambient light, human eyes adjust their sensitivity automatically, which makes the display look dimmer and display readability becomes worse as ambient brightness increases. In any condition, device readability is a signal to noise issue, where the signal is the display backlight brightness and the noise is unwanted light, such as reflected light of the sky, buildings, a human face, sunlight, and other unwanted light and reflections. In strong ambient light conditions, the signal to noise reduces, which makes the display difficult to view and read.

To enhance the outdoor readability, displays increase the display signal to increase the signal to noise ratio. For example, a transmissive display increases its backlight brightness to improve readability in bright ambient light conditions. However, this requires additional power, which reduces the battery life of the device. As another example, transflective displays add a reflector in the pixels, which can improve viewability in outdoor conditions. However, a transflective display does not use its backlight as efficiently as a transmissive display, which results in it also requiring more power. Furthermore, indoor viewability of a transflective display is not as good as transmissive displays. Additionally, outdoor viewability of a transmissive display is acceptable, but not great.

Thus, there is a need for an apparatus for enhancing display readability in an environment with strong ambient light.

### BRIEF DESCRIPTION OF THE DRAWINGS

In order to describe the manner in which advantages and features of the disclosure can be obtained, a description of the disclosure is rendered by reference to specific embodiments thereof which are illustrated in the appended drawings. These drawings depict only example embodiments of the disclosure and are not therefore to be considered to be limiting of its scope.

FIG. 1 is an example block diagram of a system according to a possible embodiment;

FIG. 2 is an example illustration of a graph of wavelengths of light from different device displays according to a possible embodiment;

FIG. 3 is an example illustration of a graph of wavelengths of light from different ambient light sources according to a possible embodiment;

FIG. 4 is an example illustration of different layers that can be used with a lens according to a possible embodiment; and

FIG. 5 is an example illustration of a display device in different ambient light conditions according to a possible embodiment.

### DETAILED DESCRIPTION

Embodiments provide an apparatus for enhancing display readability in an environment with strong ambient light. The apparatus can include an eyewear frame configured to be worn by a user, the eyewear frame including a lens holding portion. The apparatus can include at least one lens connected to the lens holding portion of the eyewear frame. The apparatus can include a multi-band pass filter coupled to the at least one lens. The multi-band pass filter can be configured to pass visible red, visible green, visible blue, and visible yellow light emitted through the lens from the display and configured to attenuate other visible and non-visible wavelengths of light through the lens.

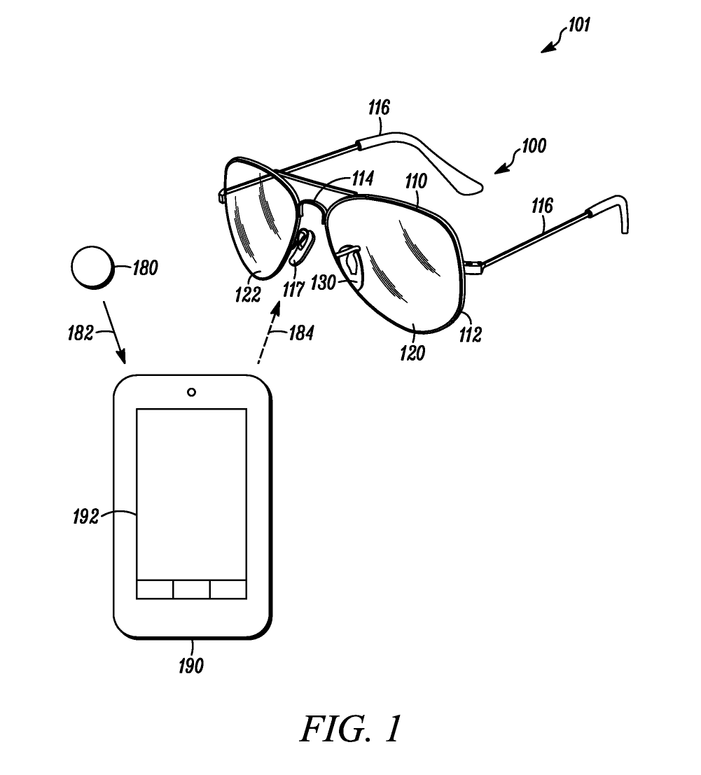

FIG. 1 is an example block diagram of a system 101 according to a possible embodiment. The system can include an apparatus 100, a display device 190, and a light source 180. The display device 190 can include a display 192. The display device 190 can be a portable electronic device, such as a smartphone, a tablet computer, a cellular phone, a portable media player, or other user portable device, which is defined as a device that a user can easily carry in the user's hand or pocket. The display device can also be a laptop, a personal computer, a television, or other device that can include a display that can be affected by glare and reflections from environmental ambient light. The light source 180 can be as source of strong ambient light 182, such as bright outdoor ambient light sunlight, reflected light, neon signs, streetlights, or other outdoor ambient light that makes a display difficult to read. The strong ambient light 182 can also be from bright indoor ambient light, such as from fluorescent lights, sports venue lights, incandescent bulbs, and other indoor ambient light that makes a display difficult to read. For example, the display 192 can reflect the ambient light 182 as reflected light 184, which can make the display 192 difficult to read.

The apparatus 100 can be eyewear, such as glasses, a monocle, goggles, or other eyewear. The apparatus 100 can enhance readability of the display 192 in an environment with strong ambient light 182. The apparatus 100 can include an eyewear frame 110 configured to be worn by a user. The eyewear frame 110 can include a lens holding portion 112, such as a rim, eye wire, or other lens holding portion. The apparatus 100 can include at least one lens 120 connected to the lens holding portion 112 of the eyewear frame 110. The at least one lens 120 can be a single lens for one eye of a user, can be a single lens for both eyes of a user, can include two lenses for each eye of a user, or can be any other eyewear lens.

The apparatus 100 can include a multi-band pass filter 130 coupled to the at least one lens 120. The multi-band pass filter 130 can have a full width at half maximum passing wavelength of 2 nm to 20 nm. The multi-band pass filter 130 can pass visible red, visible green, and visible blue, emitted through the lens 120 from the display 192 along with visible yellow light, and can attenuate other visible and non-visible wavelengths of light through the lens. According to another embodiment, the multi-band pass filter can attenuate blue light. The multi-band pass filter 130 can be coated upon the lens 120, laminated on the lens 120, integral with the lens 120, incorporated into the lens 120 or otherwise coupled to the lens 120. The multi-band pass filter 130 can be a dye-type multi-band pass filter, a pigment-type multi-band pass filter, a rugate multi-band pass filter, or any other multi-band pass filter that can pass some wavelengths of light and attenuate other wavelengths of light. The multi-band pass filter 130 can further be a reflective multi-band pass filter. For example, a reflective multi-band pass filter can reflect unwanted light and can pass, such as transmit or emit, desired light. The multi-band pass filter 130 can also be an absorptive multi-band pass filter that absorbs unwanted light and passes desired light or can be any other filter that attenuates unwanted light and passes desired light. The multi-band pass filter 130 can attenuate all wavelengths other than visible red, visible green, visible blue, and visible yellow light. The multi-band pass filter 130 can also be an active filter that can be electrically tunable for selection of different wavelengths for reading different displays or for different environmental conditions. For example, the multi-band pass filter 130 can be tunable using Microelectromechanical Systems (MEMS), can be tunable based on an interferometric effect, or can otherwise be spectrally adjustable to be wavelength selective for different displays and/or conditions.

The attenuated wavelengths of the multi-band pass filter 130 can be selected to block ambient light reflected from the display 192 of the device 190 and selected to pass wavelengths of light generated by the display 192 of the device 190. The display 192 can be a Light Emitting Diode (LED) display, an Organic LED (OLED) display, a Liquid Crystal Display (LCD), an Active-Matrix Organic Light-Emitting Diode (AMOLED) display, a MEMS display, or any other display that can be used as a display for a device. The wavelengths can be specifically attenuated to optimize viewing specifically for electronic device displays or for a specific electronic device display.

The eyewear frame 110, the lens holding portion 112, the at least one lens 120, and the multi-band pass filter 130 can be unitary, such as made of the same material or different elements of combinations of elements can be different sections made of different materials. One or both of the two lenses 120 and 122 can include the multi-band pass filter 130. The eyewear frame 110 can also include temples 116, can include nose pads 117, or can be any other configuration for an eyewear frame. All of the illustrated elements of the eyewear frame 110 are not required. For example, the eyewear frame 110 and the lens holding portion 112 may be only a bridge, such as the bridge 114, that rests on a user's nose and connects two lenses 120 and 122 including the at least one lens 120.

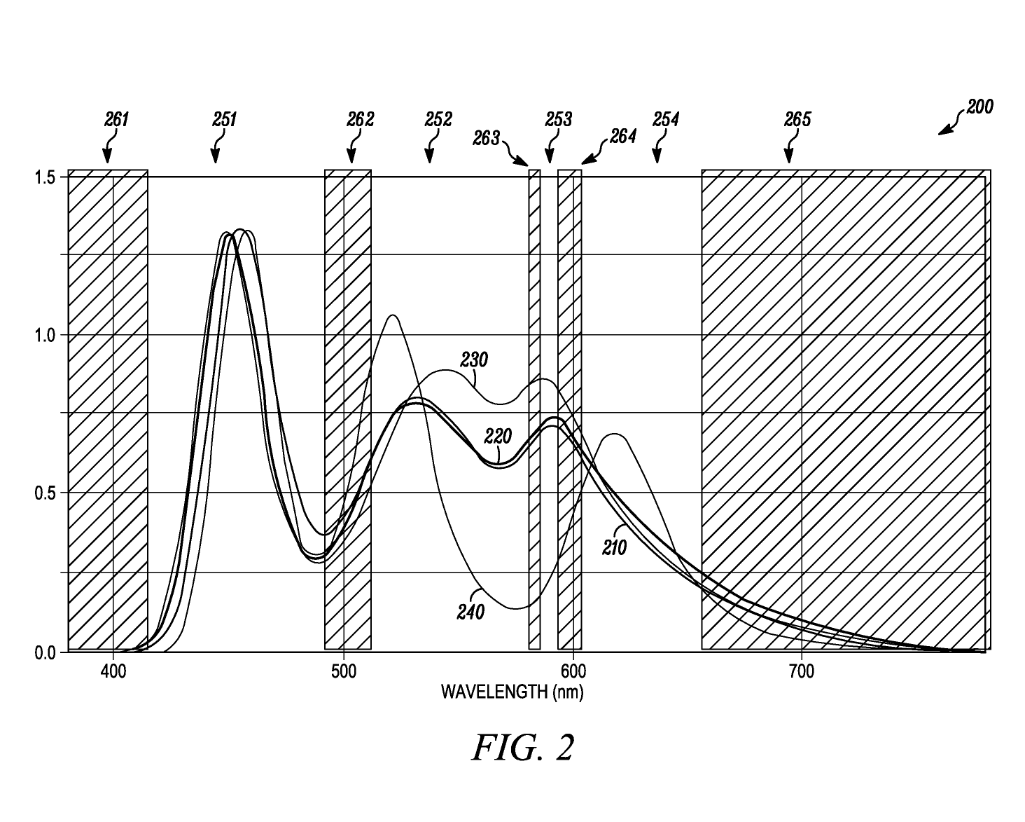

FIG. 2 is an example illustration of a graph 200 of spectrum of light from different device displays according to a possible embodiment. The spectrum can include first wavelengths 210 from a first display, second wavelengths 220 from a second display, third wavelengths 230 from a third display, and fourth wavelengths 240 from a fourth display. The first wavelengths 210 and second wavelengths 220 can be from Liquid Crystal Displays (LCD) of a first type. The third wavelengths 230 can be from a LCD of a second type. The fourth wavelengths 240 can be from an Active-Matrix Organic Light Emitting Diode (AMOLED) display. As shown, different displays can emit wavelengths of light with different peaks. For example, color displays, including LCD an AMOLED, can have three primary colors, such as red, green, and blue, which means light coming out from displays has three peaks in spectrum. Other color displays can also emit yellow light or other spectrums of light. The multi-band pass filter 130 can be optimized for different displays by taking into account the different wavelength profiles of the displays and passing desirable light while attenuating undesirable light. The multi-band pass filter 130 can also pass yellow light for improved vision of both the display and other objects in a user's environment, such as yellow traffic lights.

The graph 200 also shows passed bands of light 251-254 and attenuated bands of light 262-265 from the multi-band pass filter 130 for a generic multi-band pass filter that can work for all display types or that can work for LCD type displays. The multi-band pass filter 130 can pass visible blue light 251, visible green light 252, visible yellow light 253, and visible red light 254. The multi-band pass filter 130 can also attenuate electromagnetic wavelengths 261 below 420 nm, attenuate electromagnetic wavelengths 262 between 492 and 515 nm, attenuate electromagnetic wavelengths 263 and 264 between 570 and 603 nm while passing at least some yellow light 253, and attenuate electromagnetic wavelengths 265 above 665 nm. For example, the multi-band pass filter can pass yellow light with a wavelength somewhere between 570 and 590 nm within the attenuation band of 570 and 603 nm. This can include band yellow light electromagnetic wavelengths in a band centered at a wavelength between 575 and 590 nm with a bandwidth between 10 and 25 nm, a bandwidth between 15 and 20 nm, or a combination thereof.

According to another embodiment, the multi-band pass filter 130 can attenuate electromagnetic wavelengths 261 below 420 nm, electromagnetic wavelengths in a band 262 centered at a wavelength between 500 and 510 with a bandwidth between 15 and 30 nm, electromagnetic wavelengths in a band 263 and 264 centered at a wavelength between 575 and 595 with a bandwidth between 20 and 35 nm while passing at least some yellow light 253, and electromagnetic wavelengths 265 above 665 nm. For the yellow light, the multi-band pass filter 130 can attenuate wavelengths in bands 263 and 264 centered in wavelengths surrounding the yellow light 253 each with bandwidths between 5 nm and 20 nm. The bandwidths of all of the attenuated wavelength bands can be greater than 3 nm. The band center frequencies and the bandwidth frequencies can be selected based on characteristics of a selected display to pass colors emitted by the selected display and to filter out ambient light. As mentioned above, different displays can emit different wavelengths of red, green, blue, yellow, and other light and the colors of light passed by the multi-band pass filter 130 and attenuated by the by the multi-band pass filter 130 can be selected based on the colors emitted by the selected display. The multi-band pass filter 130 can further attenuate all or some wavelengths in the attenuated bands. For example, the multi-band pass filter 130 can attenuate visible light above visible red wavelengths and visible light below visible blue wavelengths. The multi-band pass filter 130 can additionally pass blue wavelengths, such as in a range of 450-495 nm, can pass green wavelengths, such as in a range of 495-570 nm, can pass yellow wavelengths, such as in a range of 570-590 nm, and can pass red wavelengths, such as in a range of 620-740 nm.

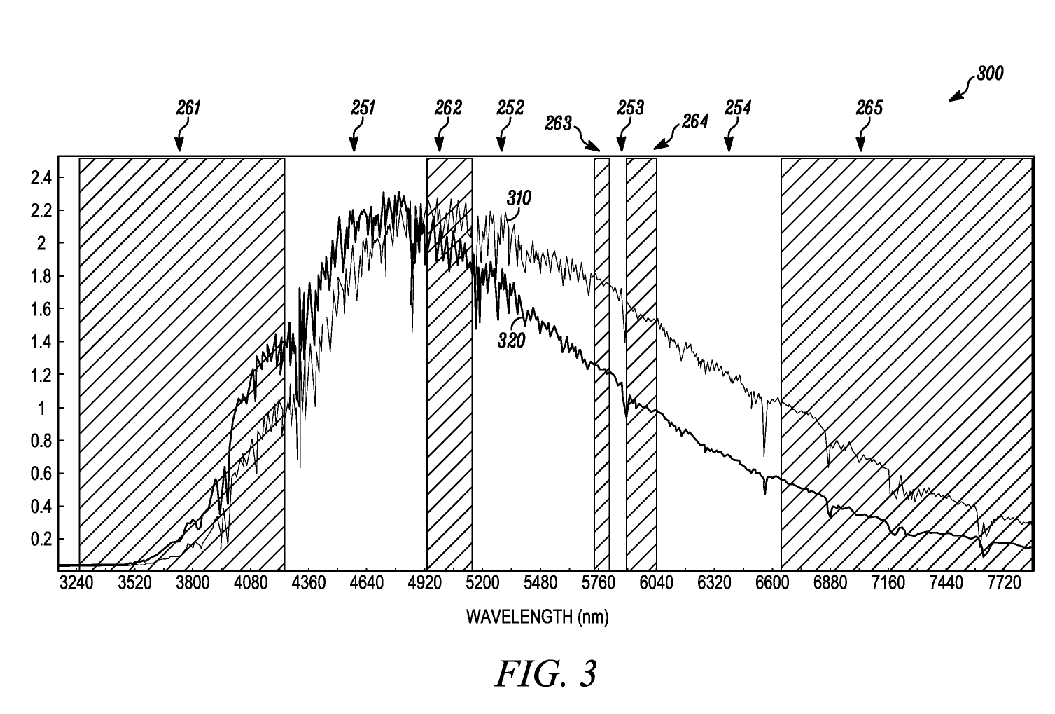

FIG. 3 is an example illustration of a graph 300 of a spectrum of light 310 and 320 from different ambient light sources according to a possible embodiment. The spectrum of light can include sun wavelengths 310 through the atmosphere from the sun and blue sky wavelengths 320 from a blue sky. For example, natural outdoor light has a broad spectrum of light. This means the unwanted reflection of the ambient light, such as glare, from a display surface also has broad spectrum. The graph 300 shows passed bands of light 251-254 and attenuated bands of light 262-265 from the multi-band pass filter 130, which can reduce glare and improve viewability of a display. The attenuated and passed wavelengths of the multi-band pass filter 130 can be optimized for specific ambient light, such as for outdoor sunlight, for florescent light, for incandescent light, or for other light that makes a display difficult to read. Furthermore, the attenuated and passed wavelengths of the multi-band pass filter 130 can be optimized for different people with different sensitivity to different wavelengths of light. For example, some people may be more sensitive to different wavelengths of light than others and the multi-band pass filter can reduce certain wavelengths and enhance other wavelengths depending on a given person's, or subset of people's, sensitivity to different wavelengths of light.

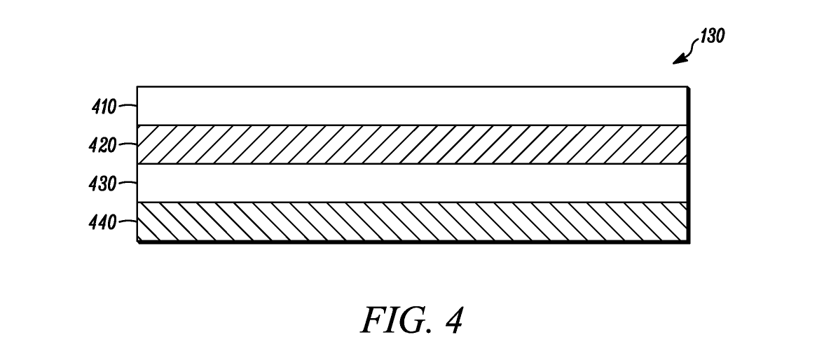

FIG. 4 is an example illustration of different layers that can be used with the lens 130 according to a possible embodiment. The layers of the lens 130 can include a glass layer 410, a multi-band pass filter layer 420, a quarter wave plate layer 430, and a polarizer layer 440. The layers 410-440 can be separate layers or the functions or some functions of each layer can be incorporated into one layer. The layers 410-440 can also be arranged in a different order. The quarter wave plate layer 430 and the polarizer layer 440 can reduce glare. When adding a polarizer when the apparatus 100 has two lenses, one lens can have a circular polarizer with a clockwise polarizing characteristic and the other lens can have a circular polarizer with a counterclockwise polarizing characteristic for viewing three dimensional images. The two lenses can also have the same circular polarizing characteristic depending on desired results.

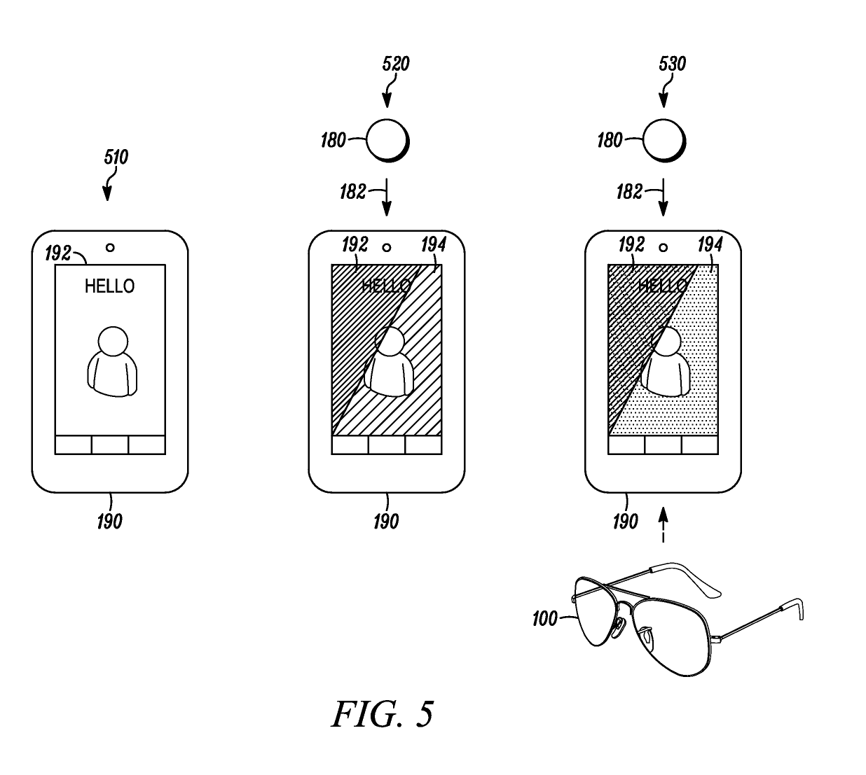

FIG. 5 is an example illustration of the display device 190 with the display 192 in different ambient light scenarios 510-530 according to a possible embodiment. In the first scenario 510, there is no strong ambient light. Thus, the display 192 is easy to read with good contrast. In the second scenario 520, bright light 182 from a light source 180, such as the sun, washes out the display 192 and emphasizes reflections 194 making the display 192 difficult to read. In the third scenario with the same bright light 182, the display 192 is easier to read when viewed through the eyewear apparatus 100. It is noted that in some scenarios the reflections 194 on the display 192 may be darker than reflected ambient light, but the illustrated shading is inverted in scenarios 520 and 530 to highlight the improvement in readability using the eyewear apparatus 100.

Embodiments can provide for improved readability of a display in the presence of strong ambient light when using eyewear with a multi-band pass filter. A lens of eyewear can be defined so only useful light, such as spectra, can pass, which improves the signal to noise ratio of the display when viewed through the eyewear in strong ambient light conditions. The color light from the display can pass through the eyewear and unwanted noise from ambient light and surface glare can be blocked by the eyewear to improve the perceived contrast and color of the display. For example, the eyewear can reduce glare and pass wavelengths of light specific to a display, such as red, green, and blue light, along with yellow light, while attenuating some of the broad spectrum of wavelengths of light that are reflected from ambient light and otherwise not provided by the display.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The phrase “at least one of” followed by a list is defined to mean one, some, or all, but not necessarily all of, the elements in the list. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.” Furthermore, the background section is written as the inventor's own understanding of the context of some embodiments at the time of filing and includes the inventor's own recognition of any problems with existing technologies and/or problems experienced in the inventor's own work.

We claim:

1. An apparatus for enhancing readability of a display in an environment with strong ambient light, the apparatus comprising:
an eyewear frame configured to be worn by a user, the eyewear frame including a lens holding portion;
at least one lens connected to the lens holding portion of the eyewear frame; and
a multi-band pass filter coupled to the at least one lens, the multi-band pass filter configured to pass visible red, visible green, and visible blue light, emitted through the lens from the display along with visible yellow light, and configured to attenuate other visible and non-visible wavelengths of light through the lens.

2. The apparatus according to claim 1, wherein the multi-band pass filter is configured to attenuate electromagnetic wavelengths below 420 nm, attenuate electromagnetic wavelengths between 492 and 515 nm, attenuate electromagnetic wavelengths between 570 and 603 nm while passing at least some yellow light, and attenuate electromagnetic wavelengths above 665 nm.

3. The apparatus according to claim 1, wherein the multi-band pass filter is configured to attenuate electromagnetic wavelengths below 420 nm, electromagnetic wavelengths in a band centered at a wavelength between 500 and 510 with a bandwidth between 15 and 30 nm, electromagnetic wavelengths in a band centered at a wavelength between 575 and 595 with a bandwidth between 20 and 35 nm while passing at least some yellow light, and electromagnetic wavelengths above 665 nm.

4. The apparatus according to claim 3, wherein the band center frequencies and the bandwidth frequencies are selected based on characteristics of a selected display to pass colors emitted by the selected display and to filter out ambient light.

5. The apparatus according to claim 1, wherein the bandwidths of the attenuated wavelengths are greater than 3 nm.

6. The apparatus according to claim 1, wherein the attenuated wavelengths are selected to block ambient light reflected from a display of a portable electronic device and selected to pass wavelengths of light generated by the display of the portable electronic device.

7. The apparatus according to claim 1, further comprising a quarter wave plate and a polarizer coupled to the lens and the multi-band pass filter, where the quarter wave plate and the polarizer are configured to reduce glare coming from a user and reflected back to the eyes of the user.

8. The apparatus according to claim 1, wherein the multi-band pass filter attenuates blue light.

9. The apparatus according to claim 1, wherein the multi-band pass filter comprises a reflective multi-band pass filter.

10. The apparatus according to claim 1, wherein the wherein the multi-band pass filter has a full width at half maximum passing wavelength of 2 nm to 20 nm.

11. The apparatus according to claim 1, wherein the multi-band pass filter is incorporated into the at least one lens.

12. An apparatus for enhancing readability of a display in an environment with strong ambient light, the apparatus comprising:
an eyewear frame configured to be worn by a user, the eyewear frame including a lens holding portion;
at least one lens connected to the lens holding portion of the eyewear frame; and
a reflective multi-band pass filter coupled to the at least one lens, the reflective multi-band pass filter configured to pass visible red, visible green, and visible blue light emitted through the lens from the display along with visible yellow light, and configured to attenuate other visible and non-visible wavelengths of light through the lens,
wherein the reflective multi-band pass filter is configured to attenuate electromagnetic wavelengths below 420 nm, attenuate electromagnetic wavelengths between 492 and 515 nm, attenuate electromagnetic wavelengths between 570 and 603 nm while passing at least some yellow light, and attenuate electromagnetic wavelengths above 665 nm.

13. The apparatus according to claim 12, wherein the multi-band pass filter is configured to attenuate electromagnetic wavelengths below 420 nm, electromagnetic wavelengths in a band centered at a wavelength between 500 and 510 with a bandwidth between 15 and 30 nm, electromagnetic wavelengths in a band centered at a wavelength between 575 and 595 with a bandwidth between 20 and 35 nm while passing at least some yellow light, and electromagnetic wavelengths above 665 nm.

14. The apparatus according to claim 12, wherein the bandwidths of the attenuated wavelengths are greater than 3 nm.

15. The apparatus according to claim 12, further comprising a quarter wave plate and a polarizer coupled to the lens and the multi-band pass filter, where the quarter wave plate and the polarizer are configured to reduce glare that interferes with a user's view of the display.

16. The apparatus according to claim 12, wherein the multi-band pass filter attenuates blue light.

17. The apparatus according to claim 12, wherein the wherein the multi-band pass filter has a full width at half maximum passing wavelength of 2 nm to 20 nm.

18. A system for enhancing readability of a display in an environment with strong ambient light, the system comprising:
a portable electronic device including a specific display that is specific to the portable electronic device; and
eyewear including:
an eyewear frame configured to be worn by a user, the eyewear frame including a lens holding portion;
at least one lens connected to the lens holding portion of the eyewear frame; and
a multi-band pass filter coupled to the at least one lens, the multi-band pass filter configured to pass visible red, visible green, and visible blue light emitted through the lens from the display and configured to attenuate other visible and non-visible wavelengths of light through the lens, where the wavelengths of passed visible red, visible green, and visible blue light are based on wavelengths of visible red, visible green, and visible blue light emitted by the specific display of the portable electronic device.

19. The system according to claim 18, wherein the multi-band pass filter is configured to attenuate electromagnetic wavelengths below 420 nm, electromagnetic wavelengths in a band centered at a wavelength between 500 and 510 with a bandwidth between 15 and 30 nm, electromagnetic wavelengths in a band centered at a wavelength between 575 and 595 with a bandwidth between 20 and 35 nm, and electromagnetic wavelengths above 665 nm.

20. The system according to claim 19, wherein the band center frequencies and the bandwidth frequencies are selected based on characteristics of the specific display to pass colors emitted by the selected display and filter out ambient light.
